(19) United States
(12) Patent Application Publication
(10) Pub. No.: US 2008/0045255 A1
(43) Pub. Date: Feb. 21, 2008

(54) METHOD OF TRANSMITTING SCHEDULING INFORMATION BY A WIRELESS COMMUNICATION DEVICE AND A WIRELESS COMMUNICATION DEVICE

(75) Inventors: AGNES M. REVEL, SOUTHAMPTON (GB); RICHARD C. BURBIDGE, HOOK (GB); KENNETH J. CRISLER, LAKE ZURICH, IL (US); NICK W. WHINNETT, MARLBOROUGH (GB)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/465,869

(22) Filed: Aug. 21, 2006

(51) Int. Cl. H04B 7/00; H04Q 7/20

(52) U.S. Cl. 455/510

(57) ABSTRACT

A method of transmitting scheduling information by a wireless communication device (200) to a network (112) for allocation of resources to the wireless communication device, comprises the steps of transmitting (500) to the network first scheduling information (SI1) relating to a first resource requirement and re-transmitting (516) the first scheduling information when the first scheduling information is not received by the network. Second scheduling information (SI2) relating to a second resource requirement subsequent to the first resource requirement is transmitted (512) to the network (112) in response to one of the first scheduling information having been received by the network and the first scheduling information having not been received by the network after a predetermined number of re-transmissions of the first scheduling information. The generation of scheduling information may be initiated in response to a trigger event such as a periodic trigger event or a non-periodic trigger event.

### FIELD OF THE DISCLOSURE

The disclosure relates to a method of transmitting scheduling information by a wireless communication device and a wireless communication device.

### BACKGROUND

High Speed Downlink Packet Access (HSDPA) provides increased data speeds (for example, up to 14.4 Mbps) on the downlink from base stations to mobile terminals for 3G communication systems such as Universal Mobile Telecommunication Systems (UMTS) CDMA based wireless communication systems. In UMTS, the base stations are known as Node Bs and a mobile terminal is known as User Equipment (UE). Standards for HSDPA have been established within the Third Generation Partnership Project (3GPP). Standards are now being developed within 3GPP for High Speed Uplink Packet Access (HSUPA) to enable the uplink from the UE to the Node B to be able to handle increased data speeds (for example, up to 5.76 Mbps). HSUPA will be particularly useful in applications such as video streaming, video conferencing, real-time games, music, email and MMS which applications will benefit from better performance in uplink data transmission.

In 3GPP Release 6 HSUPA, increased data speeds are supported by an Enhanced Dedicated Channel (E-DCH), and by an Enhanced Dedicated Physical Data Channel (E-DPDCH) which carries the E-DCH. An enhanced MAC entity (MAC-es/MAC-e) has been added below the MAC-d layer in the UE to support E-DCH traffic.

In the 3GPP Medium Access Control (MAC) Protocol Specification TS 25.321 (Release 6) and the Radio Resource Control (RRC) Specification TS 25.331, V7.0.0, scheduling information (SI) is sent as part of the MAC-e protocol data unit (PDU) when the UE requires resources from a Node B. MAC-e protocol data units (PDUs) are transmitted by the UE to the Node B on an Enhanced Dedicate Channel (E-DCH) which is in turn carried by the Enhanced Dedicated Physical Data Channel (E-DPDCH). The scheduling information SI may be sent alone in the MAC-e PDU or multiplexed with data and sent in the MAC-e PDU.

Typically, a UE can communicate at any time with a number of cells in the communication system, with each cell being controlled by a Node B. The cells in communication with the UE include a serving cell and non-serving cells. The Node B of the serving cell makes decisions for the UE, such as the scheduling decisions for the UE and thus, the scheduling information is sent from the UE to the serving Node B via a serving E-DCH radio link.

The scheduling information sent to the serving Node B from the UE includes information to provide a scheduler located in the Node B with all the information it needs to decide what uplink resources to allocate to the UE: that is, the scheduling information provides the serving Node B with information concerning the amount of resources needed by the UE and the amount of resources the UE can use. Based on the scheduling information received at the serving Node B from the UE, the serving Node B makes a decision on the resources to allocate to the UE. For example, Node B will decide on the data transmission rate to be used by the UE which ensures that the signal to noise power ratio is at a required level. The downlink scheduling control signals sent by the Node Bs to the UEs are Absolute Grant (AG) sent from the Node B controlling the serving cell only and Relative Grant (RG) sent from a Node B controlling the serving cell and/or a Node B controlling a non-serving cell. AG determines the absolute value of the power offset permitted for power usage by the UE and RG is used for controlling fluctuations for power offset due to interference from neighbouring cells.

Typically, there can be multiple logical channels in the UE in which data is buffered and available for transmission and the priorities for each of the logical channels will vary depending on the type of buffered data. For example, a logical channel having buffered data for video streaming will be assigned a higher priority than a logical channel having buffered data for a web browsing session.

The scheduling information includes the logical Channel ID (HLID) of the highest priority channel for which there is data buffered, the buffer status (HLBS) of the logical channel of the highest priority and the total buffer status (TEBS) which indicates the total amount of data available for transmission across all the logical channels, including the lower priority logical channels. The scheduling information also includes UE power headroom (UPH) information indicating the ratio between the maximum available UE transmit power and the power of a corresponding dedicated physical signalling channel DPCCH.

In order to increase the probability that data is transferred correctly, HSUPA utilises a fast re-transmission scheme known as Hybrid ARQ (HARQ). HARQ in HSUPA is a ‘Stop and Wait’ ARQ mechanism between Node B and UE and is based on synchronous retransmission in uplink. When scheduling information is received correctly by a Node B e.g. without error, the Node B transmits an ARQ feedback message, known as an acknowledgement message (ACK), to the UE. When scheduling information is not received correctly, the Node B transmits an ARQ feedback message, known as a negative acknowledgement message (NACK). The same previously transmitted scheduling information will be re-transmitted from the UE by the HARQ mechanism when no ARQ feedback is received and the retransmission timer has expired or when a NACK message for the scheduling information has been received and until the maximum number of permitted re-transmissions have been reached. The 3GPP Medium Access Control (MAC) Protocol Specification TS 25.321 (Release 6), V7.0.0, section 9.2.5.1 and 11.8.1.4 provide more details as to the HARQ protocol for HSUPA.

For a certain number of re-transmissions of the scheduling information, a retransmission serial number RSN is provided as part of the re-transmitted MAC-e PDU in order to indicate to the Node B the number of times the scheduling information has been re-transmitted. After a predetermined number of retransmissions (currently in the standard specified as three), the RSN is not updated and thus, when the Node B receives re-transmitted scheduling information, it cannot determine from the RSN how many times the scheduling information has already been re-transmitted once the RSN is not updated.

It is possible for an UE to periodically send scheduling information to the serving E-DCH Node B when the UE has data to send or to send scheduling information in response to other trigger events, such as in the case of a change in buffer occupancy or change in the power headroom of the UE which may require the network to change the amount of uplink resource allocated to the UE or a handover between two Node Bs. The Radio Resource Control (RRC) Technical Specification TS 25.331, V7.1.0 specifies that the periodicity for transmitting scheduling information can be every E-DCH Transmission Time Interval (TTI), 4 ms, 10 ms, 20 ms, 50 ms, 100 ms, 200 ms, 500 ms, or 1000 ms (there are two TTI formats: 2 ms TTI and a 10 ms TTI). In the event multiple trigger events occur by the time a new transmission of scheduling information can take place, only a single scheduling information is transmitted.

Since scheduling information is transmitted periodically and/or in response to other trigger events, such as a change in buffer occupancy, change in power headroom, change of serving cell and also scheduling information is being re-transmitted, the result is that the Node B can receive scheduling information out of order, and therefore make a scheduling decision out of order and send a Grant control signal to the UE which allocates resources to the UE for scheduling information which is not the most current: that is, for scheduling information received at Node B after scheduling information for the most current state of the UE transmission buffer. Such a problem can more readily be seen from FIG. 1 which illustrates the communication flow between a UE and a serving Node B over time for the case when, for simplicity, scheduling information is transmitted periodically every 20 ms and scheduling information transmission is not triggered by other trigger events.

First scheduling information SI1, which is multiplexed with data in one MAC-e PDU, is transmitted from the UE to the serving Node B at 2. The first scheduling information SI1 is not received correctly at the serving Node B (e.g. Node B cannot decode SI1 due to errors in the received SI1) and in response, Node B sends a NACK to the UE for the first scheduling information SI1 at 4. As part of the HARQ mechanism, the first scheduling information SI1 is re-transmitted, at 6: the RSN of the re-transmission will indicate that it is a first re-transmission of the first scheduling information SI1. The first re-transmission of the first scheduling information SI1 is not received correctly at the serving Node B and in response, Node B sends a NACK message to the UE for the first scheduling information SI1 at 8. When the 20 ms period counted by a periodic trigger timer expires, the transmission of scheduling information by the UE is triggered. This includes compiling second scheduling information SI2 based on the then current buffer status and sending the second scheduling information SI2 to the Node B in a MAC-e PDU, at 10. Subsequently, in response to the NACK received from the Node B for the first scheduling information SI1 at 8, the first scheduling information SI1 is re-transmitted to Node B for a second time, at 12: the RSN of the re-transmission will indicate that it is a second re-transmission of the first scheduling information SI1. Node B receives correctly the second scheduling information SI2 and in response according to the HARQ mechanism, sends a ACK message to the UE, at 14. A Grant control signal according to the information sent in the second scheduling information SI2 is then sent by the Node B to the UE, at 16. The second re-transmission of the first scheduling information SI1 is not received correctly at the serving Node B and in response, Node B sends a NACK message to the UE for the first scheduling information SI1 at 18. In response to the NACK received from the Node B for the first scheduling information SI1, the first scheduling information SI1 is re-transmitted to Node B for a third time, at 20: the RSN of the re-transmission will indicate that it is a third re-transmission of the first scheduling information SI1. This time Node B correctly receives the first scheduling information SI1 and sends an ACK message to the UE for the first scheduling information SI1, at 22. Subsequently at 24, a Grant control signal according to the information sent in the first scheduling information SI1 is then sent by the Node B to the UE. On expiry of the 20 ms period counted by the periodic trigger timer, the transmission of third scheduling information by the UE is triggered at 26.

Since the UE receives the Grant control signal from the Node B for the second scheduling information before the Grant control signal for the first scheduling information, the resource allocation to be used by the UE is based firstly on the second scheduling information instead of being based on the first scheduling information and then based on the second scheduling information: in other words, the resource allocation to be used by the UE is set-up out of order and so may not be optimum for the current data in the transmission buffer.

There is therefore a need to address the problem of scheduling information being received out of order at Node B.

### BRIEF DESCRIPTION OF THE DRAWINGS

A method of transmitting scheduling information by a wireless communication device and a wireless communication device in accordance with embodiments of the invention will now be described, by way of example only, with reference to the accompanying figures in which:

FIG. 1 is a schematic diagram showing the flow of scheduling information between an UE and a Node B;

FIG. 2 is a block schematic diagram of a wireless communication system;

FIG. 3 is a block schematic diagram of an exemplary wireless communication device;

FIG. 4 is a schematic representation of scheduling information for transmission by a wireless communication device;

FIG. 5 is a simplified exemplary process flow diagram;

FIG. 6 is a simplified exemplary process flow diagram for additional steps for the process of FIG. 5 in the case of periodic triggering events;

FIG. 7 is a schematic diagram showing an exemplary flow of scheduling information between an UE and a Node B in the case of periodic triggering events using the method in accordance with the disclosure; and

FIG. 8 is a schematic diagram showing an exemplary flow of scheduling information between an UE and a Node B in the case of non-periodic triggering events using the method in accordance with the disclosure.

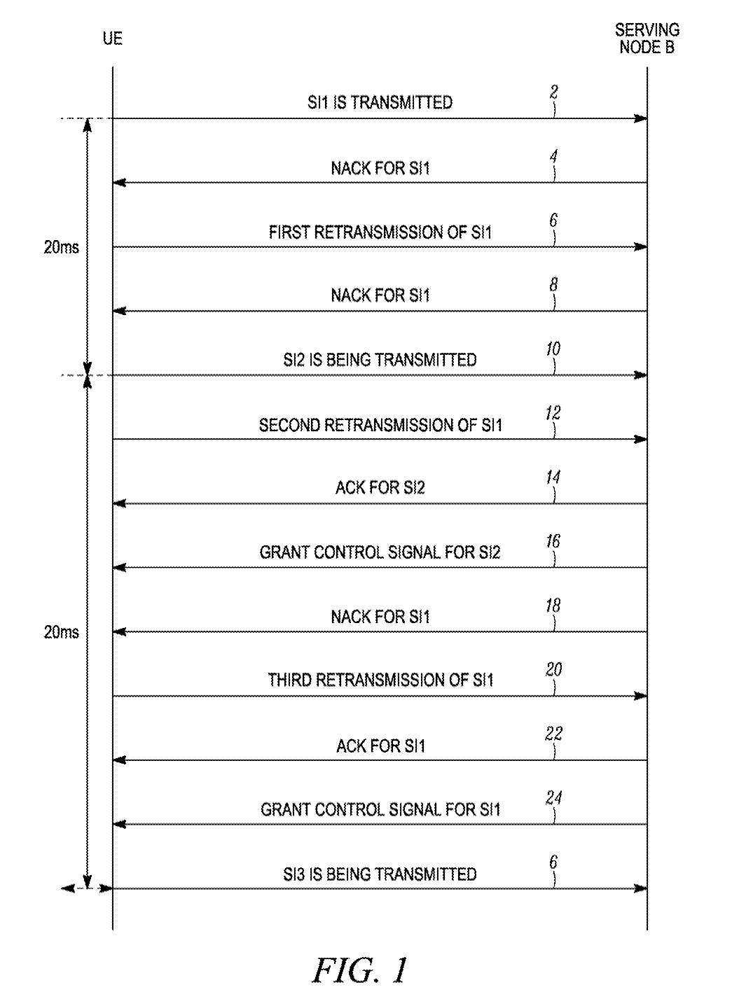

### DETAILED DESCRIPTION OF THE DRAWINGS

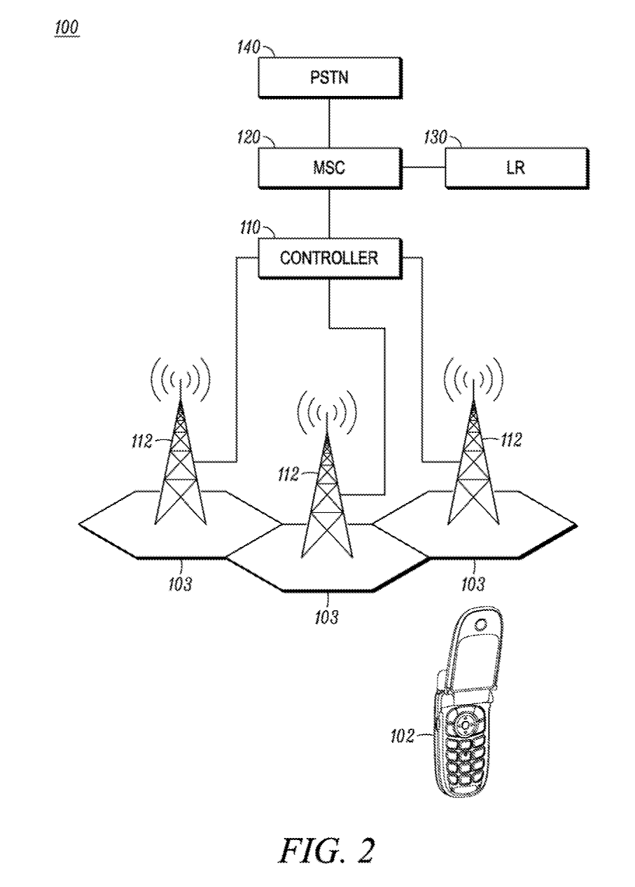

In FIG. 2, an exemplary wireless communication system 100 comprises generally a common access network including a controller 110 communicably coupled to one or more transceivers 112 that communicate with communication devices, for example, wireless mobile station (MS) 102, in corresponding cellular areas or cells 103. In an UMTS 3G W-CDMA public land mobile network (PLMN), the access network is a radio network subsystem (RNS) comprising a radio-network controller (RNC) communicably coupled to a one or more Node Bs. In FIG. 2, the radio-network controller (RNC) corresponds to the controller 110 and the Node Bs correspond to the transceivers 112. In UMTS 3G networks, the mobile station (MS) 102 is referred to as user equipment (UE). Alternatively, the exemplary PLMN may be implemented as some other existing or future generation wireless communication network.

In FIG. 2, the wireless communication system 100 also comprises generally a core network communicably coupled to the common access network. The exemplary core network includes a mobile switching centre (MSC) 120 communicably coupled to a location register (LR) 130, for example, to a visitor location register (VLR) and/or a home location register (HLR). The exemplary core network may be a UMTS 3G or some other network. In FIG. 2, the exemplary mobile switching centre 120 is communicably coupled to a public switched telephone network (PSTN) 140, for example, by a gateway mobile switching centre not illustrated but known generally by those having ordinary skill in the art. The controller 110 may also be communicably coupled to other networks, for example, to a packet network.

Such wireless communication systems are well known in the art, and therefore the specifics of such systems will not be described in detail, apart from where appropriate for the understanding of the disclosure as described herein.

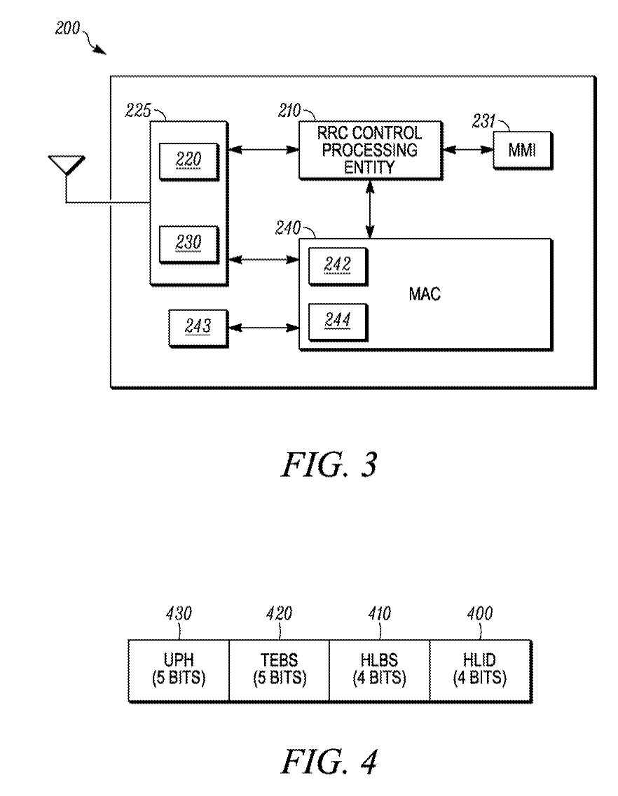

FIG. 3 is a partial schematic block diagram of an exemplary wireless communication device 200, such as the UMTS UE 102 of FIG. 2. As will be apparent to a skilled person, only those functional components of the UE 200 that are necessary for an understanding of the disclosure have been shown and will be described. The UE may be a portable or mobile telephone, a Personal Digital Assistant (PDA), a portable computer and/or similar devices.

The UE 200 comprises, among other entities well known by those having ordinary skill in the art, a control entity 210 in the form of an exemplary radio resource control (RRC) processing entity for configuration and control. The control processing entity 210 is communicably coupled to a receiving entity 220 and to a transmitting entity 230 and to a Man Machine Interface (MMI) 231, including elements such as a key pad, microphone, speaker, display screen, for providing an interface between the UE 200 and the user of the UE. The receiving entity 220 and the transmitting entity 230 are shown in FIG. 3 as part of a transceiver 225 but it will be appreciated that the receiving entity 220 and the transmitting entity 230 may be separate components of the UE 200. The control processing entity 210 is also communicably coupled to an extended medium access control (MAC-e) entity 240 including a scheduling information (SI) generation entity 242 and a MAC-e PDU generation entity 244, which are discussed further below. The UE 200 further comprises a data buffer 243 communicably coupled to the scheduling information generation entity 242 and to the MAC-e PDU generation entity 244. The data buffer 243 buffers the data available for transmission across the logical channels.

Under the control of the control processing entity 210, scheduling information (SI) is compiled or generated by the scheduling information generation entity 242, which communicates with the MAC-e PDU generation entity 244. The MAC-e PDU generation entity 244 generates the enhanced MAC PDU (MAC-e PDU) for transmission by the UE via the transmitting entity 230. MAC-e PDUs are transmitted by the UE to the Node B on an Enhanced Dedicated Channel (E-DCH) which is in turn carried by the Enhanced Dedicated Physical Data Channel (E-DPDCH). The MAC-e PDU generation entity 244 includes the generated scheduling information in a MAC-e PDU. The scheduling information SI may be sent alone in the MAC-e PDU or multiplexed with data and sent in the MAC-e PDU. In an exemplary embodiment, the presence of scheduling information is indicated in a header of the MAC-e PDU using one or more bits. For example the MAC protocol specification TS 25.321, V6.9.0 specifies that the field DDI of the PDU header indicates that scheduling information is included in the MAC-e PDU.

An exemplary format for scheduling information sent by the UE 200 to a serving Node B is shown in FIG. 4. The scheduling information comprises the identification (HLID) 400 of the logical channel of the current highest priority channel for which there is data buffered, the buffer status (HLBS) 410 of the logical channel of the current highest priority, and the total buffer status information (TEBS) 420 which indicates the total amount of data available in the data buffer 243 for transmission across all the logical channels, including the lower priority logical channels. The scheduling information also includes UE power headroom information (UPH) 430 indicating the ratio between the maximum available UE transmit power and the power of a corresponding dedicated physical signalling channel DPCCH.

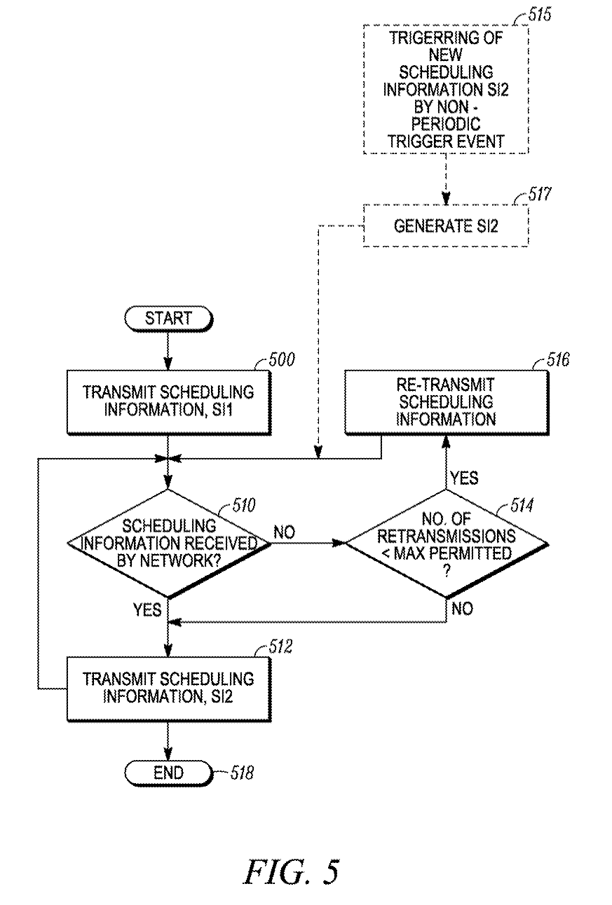

FIG. 5 shows an exemplary process flow for a method of transmitting scheduling information according to the disclosure.

At step, 500 the transmitting entity 230 of the UE 200 transmits to the network (e.g. serving Node B 112) scheduling information generated by the scheduling information generation entity 242 relating to the current resource requirement of the UE 200. At step 510, the UE 200 (for example, by means of the control processing entity 210 of the UE 200) determines whether the scheduling information has been received at the serving Node B 112 and if it has been received, new scheduling information relating to the new or subsequent resource requirement of the UE 200 is transmitted to the network, step 512. The UE 200 determines that the scheduling information has been received at the Node B 112 when an ACK acknowledgement message from the Node B 112 is received at the UE 200. If the scheduling information has not been received correctly at the network (i.e. when no ACK acknowledgement message has been received at the UE 200 and a re-transmission timer which counts the predetermined number of retransmissions has expired or if a NACK acknowledgement message has been received by the UE 200), the process moves to step 514 where it is determined (for example, by means of the control processing entity 210 of the UE 200) whether the scheduling information has been re-transmitted more than a maximum number of retransmission times, which is a predetermined number indicated in the HARQ profile for the UE which is previously signalled to the UE from the network. If the scheduling information has not been re-transmitted more than the predetermined number, the scheduling information is re-transmitted at step 516 and the flow continues with step 510. If the scheduling information has been re-transmitted more than the predetermined number, the process moves to step 512, and new scheduling information relating to the new current resource requirement of the UE 200 is transmitted to the network, Node B 112. The process then returns to step 510 to determine whether the new scheduling information has been received at the network and the process continues until an end (step 518), such as the UE being turned off.

As discussed above, previously a UE has been arranged to compile and transmit scheduling information to a serving Node B in response to a trigger event. The trigger event may be periodic trigger events (e.g. when a predetermined period counted by a periodic trigger timer expires periodically), and/or non-periodic trigger events, such as a change in the UE's buffer status, a change in the power available to the UE's (e.g. the UE's power headroom), a change in the cell serving the UE (including changing in the sector within the same serving cell), and/or a change in high priority data waiting in the UE's buffer.

In embodiments of the disclosure, for trigger events that comprise non-periodic trigger events such as a change in resource requirements of the UE and a change in the cell serving the UE (including changing in the sector within the same serving cell), the non-periodic trigger event is detected by the control processing entity 410 and the scheduling information is compiled or generated in response to a trigger event at any time in the process flow of FIG. 5 when the trigger event occurs (see for example the steps 515 and 517 in dotted lines in FIG. 5 which show a non-periodic trigger event occurring after a re-transmission at step 516) but the generated scheduling information will not be transmitted to the network until previous scheduling information has been received by the network or the previous scheduling information has not been received at the network and the predetermined number of re-transmissions has been reached as determined by steps 510 and 514 in FIG. 5. In other words, the transmission of scheduling information is initiated in response to a trigger event in that the scheduling information is generated but the transmission of the scheduling information is delayed. Trigger events involving changes in resource requirements (i.e. non-periodic trigger events) include: a change in the UE's buffer status, for example when the total E-DCH buffer status (TEBS) becomes greater than zero, a change in the power available to the UE (e.g. the UE's power headroom), and/or a change in high priority data waiting in the UE's data buffer 243, for example, when data with higher priority than the data already in the data buffer arrives.

In other embodiments when the trigger events are generated periodically at predetermined periods, the scheduling information will not be compiled or generated nor transmitted in response to the periodic trigger event if any previous scheduling information is still being transmitted or re-transmitted to the network. Periodic trigger events are timed by a periodic trigger timer (not shown) in the UE 200 which is arranged to count a predetermined period. The periodic trigger timer (not shown) may be coupled to the control processing entity 210 and the MAC entity 240 or be part of the control processing entity 210. When the predetermined period expires, the transmission of the scheduling information is triggered under the control of the control processing entity 210. The periodic trigger timer is restarted when the transmission of the scheduling information is triggered. When previous scheduling information is still to be transmitted or re-transmitted, the periodic trigger event will be ignored by the UE and no new scheduling information generated and transmitted. The periodic trigger timer will however still be restarted in response to a trigger event even if it is ignored. The periodic trigger event may occur at any point in the process flow of FIG. 5 after the scheduling information SI1 has been transmitted but will not cause any new scheduling information to be generated until step 512 in FIG. 5 can be reached.

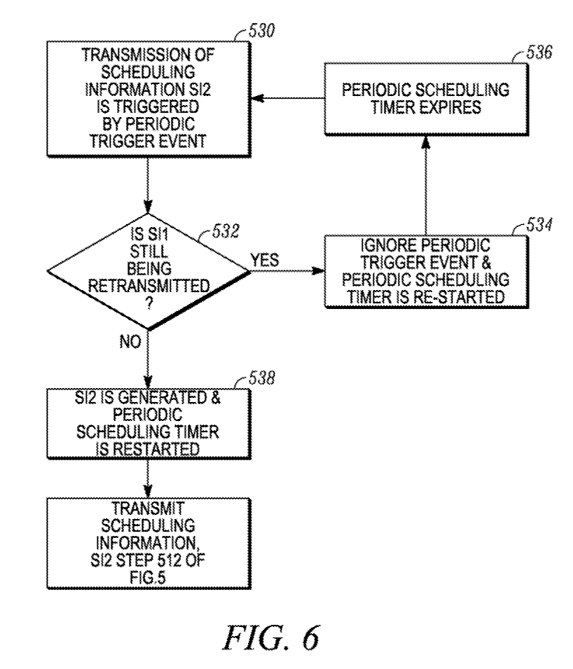

FIG. 6 shows additional steps that take place in the process flow of FIG. 5 for periodic trigger events after the scheduling information SI1 has been transmitted. At step 530, the transmission of new scheduling information SI2 is triggered or initiated by a periodic trigger event. At step 532 in response to the periodic trigger event, it is determined whether the previous scheduling information SI1 is still being transmitted or retransmitted. As discussed above, the previous scheduling information is transmitted until it has been received by the network (as indicated by an ACK message from the network) or the previous scheduling information has not been received at the network after a predetermined number of re-transmissions. This corresponds to steps 510 and 514 of FIG. 5. If the previous scheduling information SI1 is no longer being transmitted, the new scheduling information SI2 relating to a subsequent resource requirement is generated at step 538 and transmitted at step 512 of FIG. 5. The periodic trigger timer is re-started. The process then starts again at step 530 when transmission of new scheduling information is triggered by a periodic trigger event. If the previous scheduling information SI1 is still being transmitted or retransmitted, the periodic trigger event is ignored and no new scheduling information is generated and the periodic trigger timer is restarted. On expiry of the predetermined period counted by the periodic trigger timer at step 536, a new periodic trigger event occurs and the process returns to step 530.

In an alternative embodiment, scheduling information may be generated or compiled in response to a periodic trigger event but not transmitted until previously sent scheduling information has been received by the network (as indicated by an ACK message from the network) or has not been received at the network after a predetermined number of re-transmissions.

In effect, the method in accordance with the disclosure initiates the process of transmitting scheduling information by generating the scheduling information in response to a non-periodic trigger event but does not transmit the generated scheduling information to the network until previous scheduling information has been received by the network or the previous scheduling information has not been received at the network after a predetermined number or re-transmissions. In the event that multiple non-periodic trigger events occur whilst the previous scheduling information is still being re-transmitted to the network, multiple scheduling information will be generated and queued for later transmission once the previous scheduling information is no longer being retransmitted to the network. Furthermore, the method in accordance with the disclosure ignores periodic trigger events such that the scheduling information is not transmitted to the network in response to a periodic trigger event.

It will be appreciated that in some embodiments the trigger events can include periodic trigger events and the non-periodic trigger events, such as a change in the UE's buffer status, a change in the power available to the UE's (e.g. the UE's power headroom), a change in the cell serving the UE (including changing in the sector within the same serving cell), and/or a change in high priority data waiting in the UE's buffer.

In the case of a change in the serving cell, the UE 200 receives notification which originates from the RNC 110, of a change in the cell serving the UE 200. The notification is received by the UE 200 at the receiving entity 220 and is communicated to the RRC processing entity 210. In 3G UMTS applications, the notification received by the UE is embodied as a RRC message containing an E-DCH allocation. The E-DCH allocation comprises the ID of the new serving cell and also other configuration information. The scheduling information is sent in response to the notification after allocation of a new E-DCH to provide the new serving cell all the information needed to schedule the UE. In some embodiments, the scheduling information is transmitted to the new serving cell only when the UE has buffered data for transmission on a channel for which scheduling information must be sent. In these embodiments, the transmission of the scheduling information is thus conditioned on the existence of buffered data for transmission.

In the case of a trigger event such as an UE buffer status change, highest priority or power headroom change, expiry of the periodic predetermined time limit, no notification is sent by the RNC 110 to the UE 200.

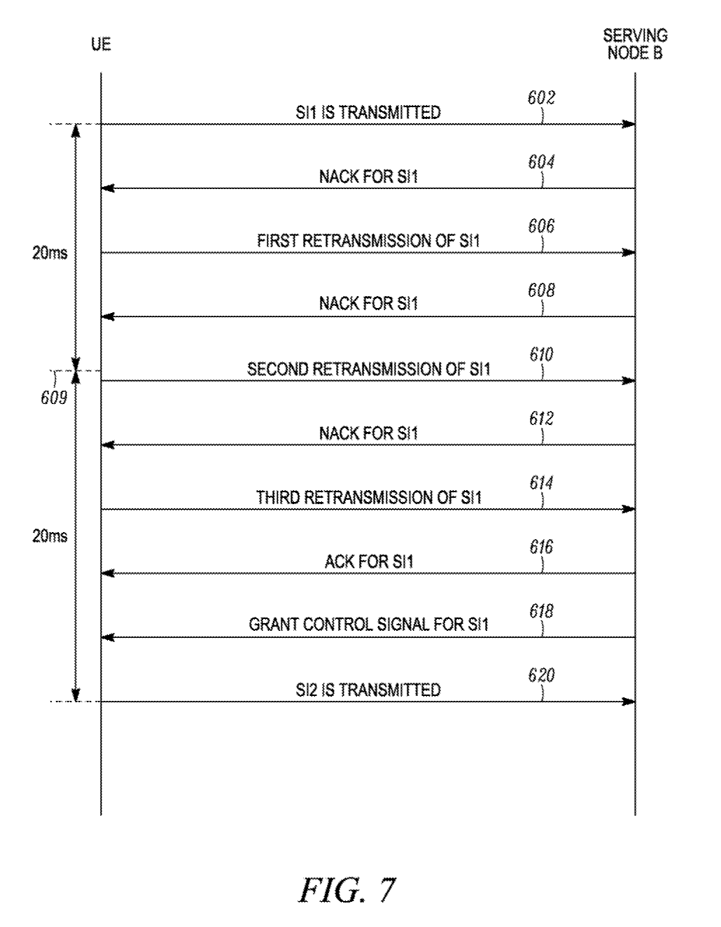

FIG. 7 shows a flow of scheduling information between an UE and a Node B using the method in accordance with the disclosure in the case when the transmission of scheduling information is triggered periodically. In the example shown in FIG. 7, the periodic predetermined period is 20 ms.

First scheduling information SI1, which is multiplexed with data in one MAC-e PDU, is transmitted from the UE to the serving Node B at 602. The first scheduling information SI1 is not received correctly at the serving Node B (e.g. Node B cannot decode SI1 due to errors in the received SI1) and in response, Node B sends a NACK to the UE for the first scheduling information SI1 at 604. As part of the HARQ mechanism, the first scheduling information SI1 is re-transmitted, at 606. The first re-transmission of the first scheduling information SI1 is not received correctly at the serving Node B and in response, Node B sends a NACK message to the UE for the first scheduling information SI1 at 608. At time 609, the 20 ms period counted by the periodic trigger timer expires but the UE ignores the trigger event and does not transmit a new scheduling information in response. However, the UE still restarts the periodic trigger timer. Subsequently, in response to the NACK received from the Node B for the first scheduling information SI1 at 608, the first scheduling information SI1 is re-transmitted to Node B for a second time, at 610. The second re-transmission of the first scheduling information SI1 is not received correctly at the serving Node B and in response, Node B sends a NACK message to the UE for the first scheduling information SI1 at 612. In response to the NACK received from the Node B for the first scheduling information SI1, the first scheduling information SI1 is re-transmitted to Node B for a third time, at 614. This time Node B correctly receives the first scheduling information SI1 and sends an ACK message to the UE for the first scheduling information SI1, at 616. Subsequently at 618, a Grant control signal according to the information sent in the first scheduling information SI1 is then sent by the Node B to the UE. At the expiry of the next 20 ms predetermined period, a new scheduling information SI2 is generated and transmitted by the UE to the Node B, at 620.

Since the second scheduling information SI2 is not sent to the serving Node B until a ACK message is received from the Node B for the first scheduling information SI1, the second scheduling information is not received by the Node B before the first scheduling information. This ensures that the scheduling information is not received and processed out of order with the result that the UE can be configured optimally for the most current data in its transmission buffer.

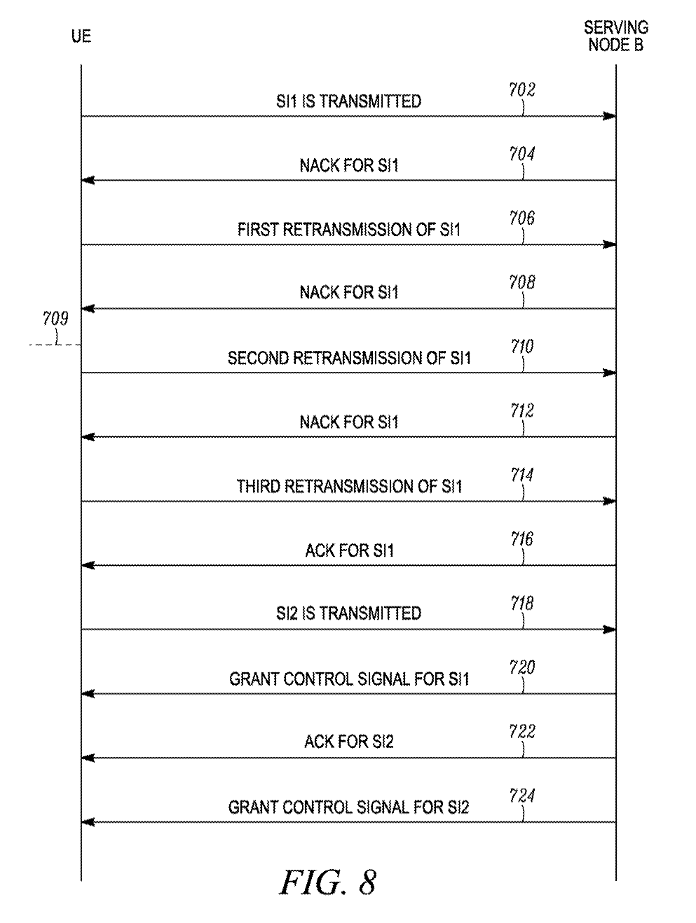

FIG. 8 shows a flow of scheduling information between an UE and a Node B using the method in accordance with the disclosure in the case when the transmission of scheduling information is triggered by a non-periodic trigger event. In the example shown in FIG. 8, the trigger event is when data with higher priority arrives in the UE transmit buffer

First scheduling information SI1, which is multiplexed with data in one MAC-e PDU, is transmitted from the UE to the serving Node B at 702. The first scheduling information SI1 is not received correctly at the serving Node B (e.g. Node B cannot decode SI1 due to errors in the received SI1) and in response, Node B sends a NACK to the UE for the first scheduling information SI1 at 704. As part of the HARQ mechanism, the first scheduling information SI1 is re-transmitted, at 706. The first re-transmission of the first scheduling information SI1 is not received correctly at the serving Node B and in response, Node B sends a NACK message to the UE for the first scheduling information SI1 at 708. At time 709, data having higher priority than the data currently in the transmit buffer of the UE arrives in the transmit buffer and represents a trigger event. In response, transmission of scheduling information is initiated and second scheduling information SI2 is compiled for the new state of the transmit buffer but the second scheduling information SI2 is not transmitted at this time since no ACK message has been received from the Node B for the first scheduling information SI1 nor has the maximum number of re-transmissions of the first scheduling information SI1 been reached. Subsequently, in response to the NACK received from the Node B for the first scheduling information SI1 at 708, the first scheduling information SI1 is re-transmitted to Node B for a second time, at 710. The second re-transmission of the first scheduling information SI1 is not received correctly at the serving Node B and in response, Node B sends a NACK message to the UE for the first scheduling information SI1 at 712. In response to the NACK received from the Node B for the first scheduling information SI1, the first scheduling information SI1 is re-transmitted to Node B for a third time, at 714. This time Node B correctly receives the first scheduling information SI1 and sends an ACK message to the UE for the first scheduling information SI1, at 716. Once an ACK message has been received for the first scheduling information SI1, the second scheduling information SI2 is transmitted by the UE to the Node B, at 718. Subsequently at 720, a Grant control signal according to the information sent in the first scheduling information SI1 is then sent by the Node B to the UE. The UE configures its resource allocation according to the Grant control signal for the first scheduling information SI1. At 722, the UE receives an ACK message from the Node B for the second scheduling information SI2. Subsequently at 724, a Grant control signal according to the information sent in the second scheduling information SI2 is then sent by the Node B to the UE. The UE configures its resource allocation according to the Grant control signal for the second scheduling information SI2.

As with the flow of FIG. 7, since the second scheduling information SI2 is not sent to the serving Node B until a ACK message is received from the Node B for the first scheduling information SI1, the second scheduling information is not received by the Node B before the first scheduling information. This ensures that the scheduling information is not received and processed out of order with the result that the UE can be configured optimally for the most current data in its transmission buffer.

In summary, the method in accordance with the disclosure does not allow for scheduling information to be transmitted to the Node B until a previous scheduling information has been received by the Node B as indicated by an ACK message from the Node B or until the previous scheduling information has been re-transmitted a predetermined number of times. The transmission of the scheduling information may further be in response to a periodic or a non-periodic trigger event. The scheduling information may be generated in response to a non-periodic trigger event but is still not transmitted until a previous scheduling information has been received by the Node B as indicated by an ACK message from the Node B or until the previous scheduling information has been re-transmitted a predetermined number of times. In the case of a periodic trigger event, the trigger will be ignored, scheduling information will not be compiled, and the periodic trigger timer is restarted.

The method in accordance with the disclosure thus ensures that the scheduling information is processed by the Node B in the correct order (i.e. the order in which they were generated) so that the UE can be configured correctly to best handle the current data in the transmit buffer.

As discussed above, the method in accordance with the disclosure may be used with any type of trigger events, including periodic and/or non-periodic events.

1. A method of transmitting scheduling information by a wireless communication device to a network for allocation of resources to the wireless communication device, the method comprising the steps of:
transmitting to the network first scheduling information relating to a first resource requirement;
re-transmitting the first scheduling information when the first scheduling information is not received by the network; and
transmitting to the network second scheduling information relating to a second resource requirement subsequent to the first resource requirement in response to one of the first scheduling information having been received by the network and the first scheduling information having not been received by the network after a predetermined number of re-transmissions of the first scheduling information.

2. The method of claim 1, further comprising initiating generating scheduling information for transmission to the network in response to a trigger event.

3. The method of claim 1, further comprising generating the second scheduling information for transmission to the network in response to a trigger event, and wherein the step of transmitting second scheduling information further comprises transmitting the generated second scheduling information after one of the first scheduling information has been received by the network and the first scheduling information has not been received by the network after a predetermined number of re-transmissions of the first scheduling information.

4. The method of claim 3, wherein the trigger event comprises at least one of a periodic trigger event and a non-periodic trigger event.

5. The method of claim 4 wherein the non-periodic trigger event includes at least one of:
a change in resource requirements of the wireless communication device; and
a change in a cell serving the wireless communication device.

6. The method of claim 5, wherein the change in resource requirements includes at least one of a change in a status of a buffer in the wireless communication device, and a change in power available to the wireless communication device.

7. The method of claim 1, wherein the wireless communication device is arranged to initiate generating scheduling information for transmission to the network in response to periodic trigger events, and wherein the method further comprises:
in response to a periodic trigger event for initiating the generation of the second scheduling information, not generating the second scheduling information when the first scheduling information has not been received by the network and the predetermined number of re-transmissions of the first scheduling information has not be reached;
generating the second scheduling information, in response to a subsequent periodic trigger event after one of the first scheduling information has been received by the network and the first scheduling information has not been received by the network after a predetermined number of re-transmissions of the first scheduling information, and wherein the step of transmitting second scheduling information further comprises transmitting the generated second scheduling information in response to the subsequent periodic trigger event.

8. The method of claim 7, wherein each periodic trigger event comprises expiry of a periodic predetermined period counted by a timer and wherein the method further comprises:
in response to a periodic trigger event for initiating the generation of the second scheduling information when the first scheduling information has not been received by the network and the predetermined number of re-transmissions of the first scheduling information has not be reached, restarting the timer for a subsequent periodic predetermined period.

9. The method of claim 1, further comprising receiving an acknowledgement message from the network indicating that the first scheduling message has been received by the network.

10. The method of claim 9, further comprising determining from the acknowledgement message that the first scheduling message has been received.

11. The method of claim 1, wherein the steps of transmitting scheduling information includes transmitting at least information relating to a data buffer of the wireless communication device and transmitting information concerning power available to the wireless communication device.

12. A wireless communication device adapted to transmit scheduling information to a network for allocation of resources to the wireless communication device, the wireless communication device comprising:
a scheduling information generation entity for generating scheduling information;
a transmitting entity communicably coupled to the scheduling information generation entity, the transmitting entity being arranged in operation to:
transmit to the network first scheduling information generated by the scheduling information generation entity relating to a first resource requirement;
re-transmit the first scheduling information when the first scheduling information is not received by the network; and
transmit to the network second scheduling information generated by the scheduling information generation entity relating to a second resource requirement subsequent to the first resource requirement when one of the first scheduling information has been received by the network and the first scheduling information has not been received by the network after a predetermined number of re-transmissions of the first scheduling information.

13. The wireless communication device of claim 12, further comprising a receiving entity for receiving an acknowledgement message from the network indicating that the first scheduling message has been received by the network.

14. The wireless communication device of claim 13, adapted to determine from the acknowledgement message that the first scheduling message has been received.

15. The wireless communication device of claim 12, wherein the scheduling information includes at least information relating to a data buffer of the wireless communication device and information concerning power available to the wireless communication device.

16. A wireless communication device adapted to generate scheduling information for transmission to a network for allocation of resources to the wireless communication device in response to a trigger event, the wireless communication device comprising:
a scheduling information generation entity for generating scheduling information relating to a resource requirement in response to a trigger event;
a transmitting entity communicably coupled to the scheduling information generation entity, the transmitting entity being arranged in operation to:
transmit to the network first scheduling information generated by the scheduling information generation entity in response to a first trigger event and relating to a first resource requirement;
re-transmit the first scheduling information when the first scheduling information is not received by the network; and
transmit to the network second scheduling information generated by the scheduling information generation entity in response to a second trigger event and relating to a second resource requirement subsequent to the first resource requirement when one of the first scheduling information has been received by the network and the first scheduling information has not been received by the network after a predetermined number of re-transmissions of the first scheduling information.

17. The wireless communication device of claim 16 wherein the trigger event includes at least one of:
a change in resource requirements of the wireless communication device; and
a change in a cell serving the wireless communication device.

18. The wireless communication device of claim 17, wherein the change in resource requirements includes at least one of a change in a status of a buffer in the wireless communication device, and a change in power available to the wireless communication device.

19. A wireless communication device adapted to initiate generating scheduling information for transmission to a network for allocation of resources to the wireless communication device in response to a periodic trigger event, the wireless communication device comprising:
a scheduling information generation entity for generating scheduling information;
a transmitting entity communicably coupled to the scheduling information generation entity, the transmitting entity being arranged in operation to:
transmit to the network first scheduling information generated by the scheduling information generation entity in response to a periodic trigger event and relating to a first resource requirement; and
re-transmit the first scheduling information when the first scheduling information is not received by the network, and wherein the scheduling information generation entity is arranged in operation to:
not generate second scheduling information relating to a second resource requirement subsequent to the first resource requirement in response to a periodic trigger event for initiating the generation of the second scheduling information when the first scheduling information has not been received by the network and a predetermined number of re-transmissions of the first scheduling information has not been reached; and
generate the second scheduling information in response to a subsequent periodic trigger event after one of the first scheduling information has been received by the network and the first scheduling information has not been received by the network after a predetermined number of re-transmissions of the first scheduling information,
and wherein the transmitting entity is arranged in operation to transmit to the network the generated second scheduling information in response to the subsequent periodic trigger event.
